(19) United States
(12) Patent Application Publication
(10) Pub. No.: US 2017/0213186 A1
(43) Pub. Date: Jul. 27, 2017

(54) SYSTEM AND METHOD FOR LOGISTICS MANAGEMENT

(71) Applicant: Rufus Labs, Inc., Los Angeles, CA (US)

(72) Inventor: Gabriel Grifoni, Los Angeles, CA (US)

(73) Assignee: Rufus Labs, Inc., Los Angeles, CA (US)

(21) Appl. No.: 15/418,343

(22) Filed: Jan. 27, 2017

Related U.S. Application Data
(60) Provisional application No. 62/287,849, filed on Jan. 27, 2016.

(51) Int. Cl. G06Q 10/08

(52) U.S. Cl. CPC G06Q 10/087; G06Q 10/0833

(57) ABSTRACT

A system and a related method for logistics management is provided, having a networked server system and at least one database that stores (a) data for registered users and (b) inventory data. The system broadcasts a task by the server system via wireless communications, to mobile computing devices; conducts a congruence assessment for each mobile device to assess whether the registered user of the device can accept the task; transmits the congruence assessment from each of the plurality of mobile devices to the server system; and assigns the task based on the congruence assessments.

### CROSS REFERENCE TO RELATED APPLICATION

This application claims the benefit of U.S. App. No. 62/287,849 filed Jan. 27, 2016, which is incorporated by reference.

### FIELD OF THE INVENTION

The present invention relates generally to logistic applications for mobile computing devices and, more particularly, to an application for managing retail or other business activities.

### BACKGROUND OF THE INVENTION

With the proliferation of mobile computing devices has come a plethora of software applications with which business can better manage their activities. Certain retail businesses use mobile devices with custom cases in order to manage inventory and print price tags for items, as a replacement to older and more cumbersome “price gun” technologies. Shipping companies have been using personal digital assistants (“PDAs”) to scan and track shipments en route, and to have customers sign for packages upon delivery. Although the technologies behind mobile computing devices have allowed them to become smaller, cheaper, and more powerful, mobile applications for business activities have remained largely stagnant and focused on replicating older technologies such as bar-code printing and scanning.

One problem that retailers face is an inability to efficiently manage orders placed on the Internet for pickup in a physical store. Some of the most prevalent complaints by customers who use in-store pickup services are long in-store waiting times due to a lack of staff, or a lack of dedicated checkout counters or staff to collect their order. Furthermore, there is a growing subset of online retailers, as well as an entire new industry of shopping fulfillment services, that offer same-day delivery, or delivery in as little as one hour. As timeliness is becoming increasingly critical to providing satisfactory customer experiences, the older and slower retail technologies mentioned above have become increasingly superannuated.

For example, certain online retailers use bulky handheld price guns to tell employees where to find an item to be shipped to a customer. This price gun, however, merely recites the aisle number or bin number of the product, and it is up to the employee user of the price gun to locate the appropriate aisle and bin. It has been reported that employees, especially more junior ones, of this retailer frequently get lost or have difficulty finding products in the retailer's large warehouses having hundreds of aisles and thousands of bins. Thus, a retailer like this one could benefit from an application that does more than merely recite an aisle number or shelving location.

It should, therefore, be appreciated that there remains a need for a system and a related method for logistics management that can address these problems and others in a faster, cheaper, and overall more efficient manner.

### SUMMARY OF THE INVENTION

Briefly, and in general terms, a system and a related method for logistics management is provided, which allows business employees to manage various tasks that would be required of them. The application can be run on any device with a computer processor having input and output capabilities and having connected storage memory. The application has been designed to run ideally on mobile computing devices, to ensure the most functionality of the application and the best user experience for an employee.

More specifically, in an exemplary embodiment, the application includes functionality for an employee of a retail business to more efficiently manage that business's product inventory. This inventory management functionality may be limited to manual input of product information, or may include a wide range of features (e.g., barcode scanning, live updating of inventory quantities and locations, price label printing, and any other features which a business may desire to improve its inventory management), or any number of features which the business or user wishes to utilize.

In a detailed aspect of an exemplary embodiment, the application is designed to be worn or carried by an employee user, such that the user has immediate access to product inventory information at all times, regardless of where the user is located in a particular store or warehouse.

In another detailed aspect of an exemplary embodiment, the application can be run on a mobile computing device with a wireless data connection (e.g., Wi-Fi, Bluetooth, or cellular radio) with which the device can synchronize information with a central server or servers to reflect inventory changes in real time.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a flowchart diagram of a set of features and actions which are included in an exemplary instance of the application being run on a mobile computing device.

FIG. 2 is a perspective view of a wrist-worn mobile computing device on which an instance of the application is being run.

FIG. 3 is a screenshot of a login screen of an instance of the application, by which a user can enter his or her credentials to begin using certain features of the application.

FIG. 4 is a screenshot of the home screen of an instance of the application, which allows a user to select an option from among several different functions of the application.

FIG. 5 is a screenshot of a task assignment overview function of an instance of the application.

FIG. 6 is a screenshot of the item navigation function of an instance of the application, for one item in the task assignment depicted in FIG. 5.

FIG. 7 is a screenshot of the item verification function of an instance of the application, for the item depicted in FIG. 6.

FIG. 8 is a screenshot of the automatic verification function of an instance of the application, for the item verification function depicted in FIG. 7.

FIG. 9 is a screenshot of the item navigation function of an instance of the application, for another item in the task assignment depicted in FIG. 5.

FIG. 10 is a screenshot of a navigational proximity warning of an instance of the application, for the item depicted in FIG. 9.

FIG. 11 is a screenshot of the item verification function of an instance of the application, for the item depicted in FIG. 9.

FIG. 12 is a screenshot of the automatic verification function of an instance of the application, for the item verification function depicted in FIG. 11.

FIG. 13 is a screenshot of the item navigation function of an instance of the application, for yet another item in the task assignment depicted in FIG. 5.

FIG. 14 is a screenshot of the item verification function of an instance of the application, for the item depicted in FIG. 13.

FIG. 15 is a screenshot of the automatic verification function of an instance of the application, for the item verification function depicted in FIG. 14.

FIG. 16 is a screenshot of the task completion overview function of an instance of the application, to be displayed upon completion of task items for a task assignment.

FIG. 17 is a screenshot of a priority message interrupt screen of an instance of the application, by which the user is notified of an urgent message superseding the user's current activity.

FIG. 18 is a screenshot of an item navigation function of an instance of the application, for an item in the priority order depicted in FIG. 17.

FIG. 19 is a screenshot of the item verification function of an instance of the application, for the item depicted in FIG. 18

FIG. 20 is a screenshot of the automatic verification function of an instance of the application, for the item verification function depicted in FIG. 19.

FIG. 21 is a screenshot of the task completion overview function of an instance of the application, to be displayed upon completion of task items for a task assignment.

FIG. 22 is a screenshot of the home screen of an instance of the application, displayed either while the user is in the process of completing a task or after the user has completed a task.

FIG. 23 is a perspective view of another wrist-worn mobile computing device on which an instance of the application is being run.

FIG. 24 is a perspective view of a mobile computing device, which can be carried by a user, on which an instance of the application is being run.

FIG. 25 is a simplified block diagram of a system in accordance with the invention

### DETAILED DESCRIPTION OF THE PREFERRED EMBODIMENTS

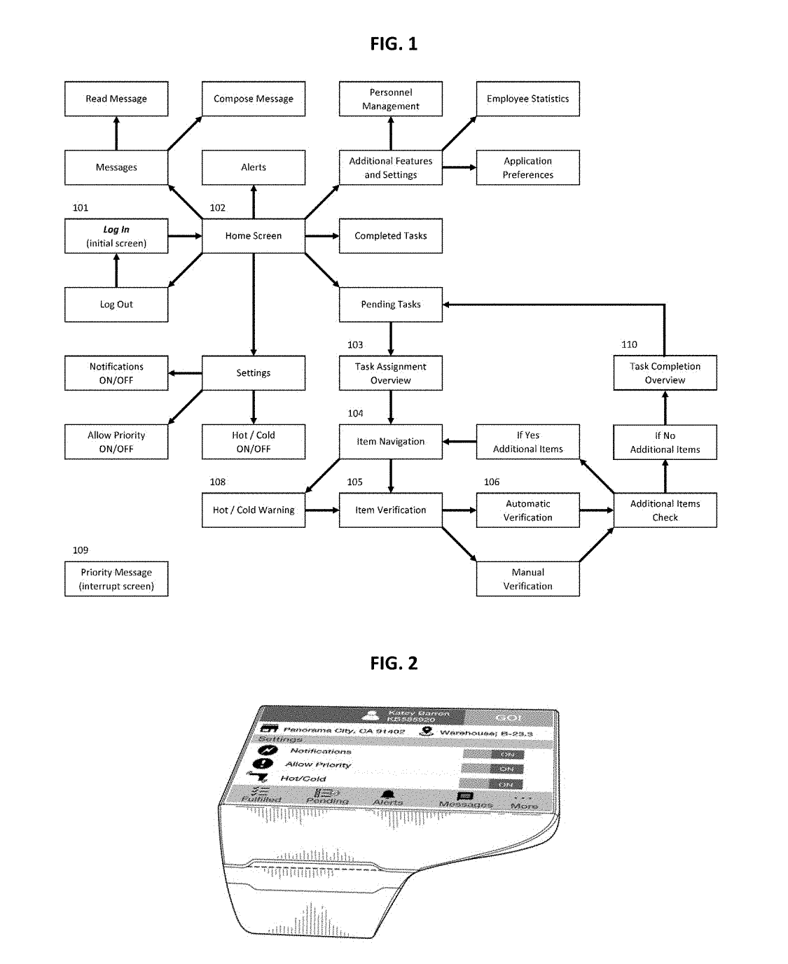

Referring now to the drawings, and particularly FIG. 1, there is shown a diagram of certain functions of a mobile application in accordance with the invention, depicting how a user would be able to navigate through the screens and menus of the application to utilize each function, to include inventory management, order fulfillment, workflow prioritization, employee management and tasking, among others.

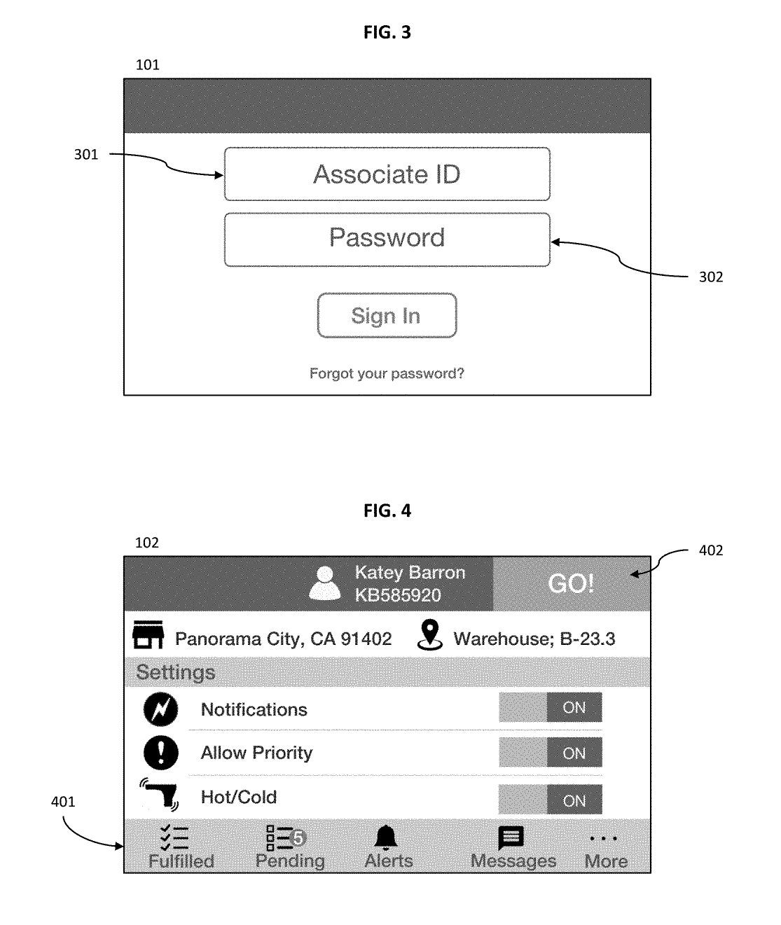

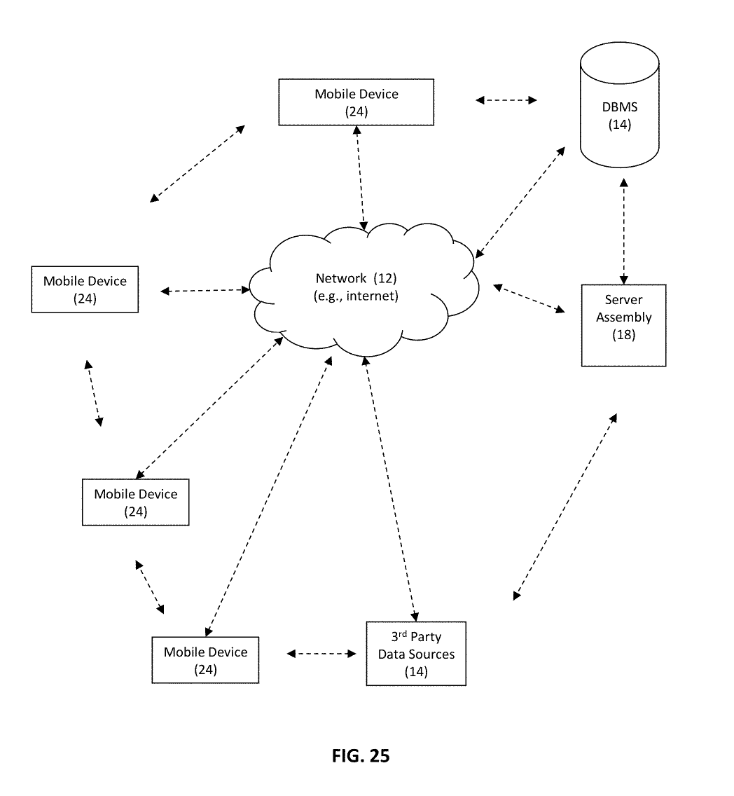

In this embodiment, upon initializing the application, the user would be presented first with a login screen 101. This login screen 101 contains a username input field 301 and a password input field 302 into which the user would input his or her credentials, as shown in FIG. 3. The device would transit this information to the networked server. When each employee user is given a unique set of credentials, the device on which the application is being run can be used by different users at different times, such that one device can be used by an employee user working a morning shift, and the same device can be used by a different employee user working an evening shift. This employee data is maintained via a database 14 (FIG. 25) in communication with the networked server 18 (FIG. 25). Upon successfully logging in, the application can mark the employee user as being clocked in at work, if the employer business desires this functionality.

It should be noted that the position or size of any of the components of the application (e.g., buttons, input fields, links, icons, or other information), and any images or logos associated with those components, need not be the same as those depicted in these figures, and in fact can be moved or altered without departing from the present invention.

After the user has signed in, the user is presented with a home screen 102 that is tailored to that particular user's permissions or the employer business's specifications. For example, a retail floor employee may have access to the information shown in FIG. 4, but a managerial employee may have access to additional information. Furthermore, the home screen 102 displays the current user's primary business property location in addition to his or her current physical position, which would differ from user to user.

The home screen 102 may also provide buttons or links 401 to other application functions. In the instance of the application depicted in FIG. 4, the row of icons 401 provides the user a choice of functions, including a function to view fulfilled or completed tasks, a function to view pending tasks, a function to view the user's alerts or notifications, and a function to view and send messages to other users.

The upper right corner of this instance of the home screen 102 displays a component 402 that displays the user's current status. This component 402 can also serve as a link to another function screen, or as a button for a function action. For example, pressing this component 402 can take the user to the pending tasks screen, or can display a reminder that the employee user is scheduled to take a ten-minute break, or can activate a switch of the current user's status to show other users that the current user is on break.

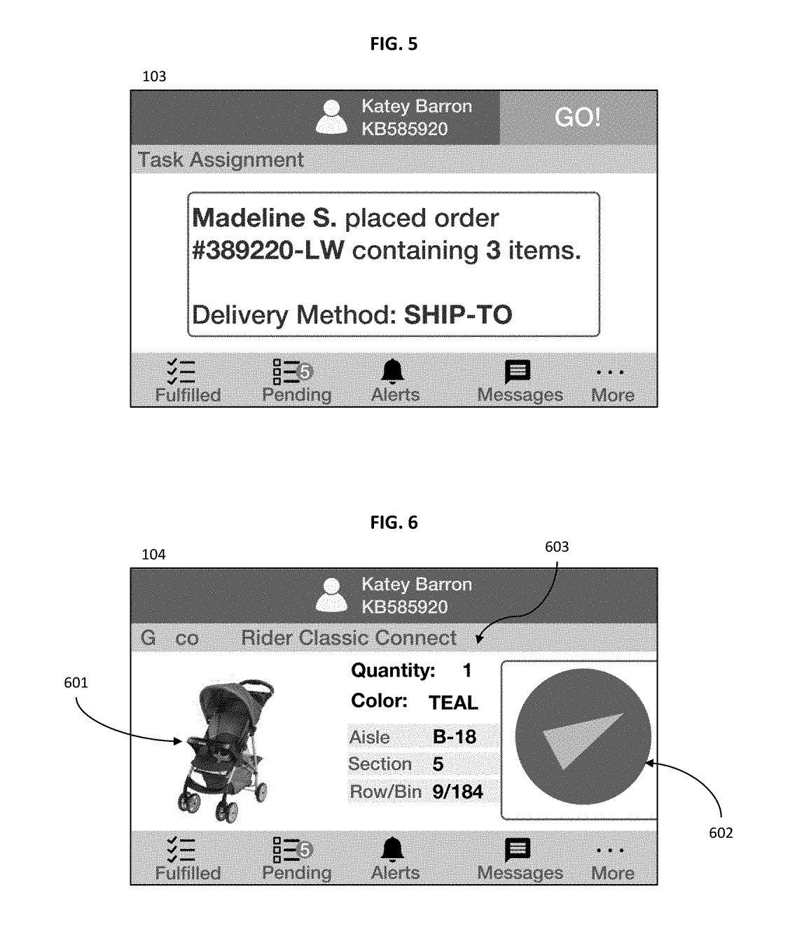

As shown in FIG. 5, the task assignment overview function 103 informs the user of certain data, via DBMS 14 (FIG. 25) regarding the active task. The application then displays the first (or only) item to be completed. In this embodiment, designed for a retail setting, the first task item is a product to be picked from a shelf. The item navigation function 104 (FIG. 6) is then displayed to the user, with an image of the item 601, a description of the item and its location 603, and any other data pertinent to the task, via DBMS 14 (FIG. 25). On the right side of the item navigation function 104 screen is displayed a compass visualization 602. This compass function 602 directs the user to the exact physical location of the item.

The compass function 602 is based on the application, or a server or servers with which the application is in communication, using a positioning system or locating engine to determine the physical location of the task item as well as the physical location of the user. Various positioning systems can be implemented with varying degrees of accuracy, depending on the requirements or desires of the employer business. For example, in some environments, it might be appropriate for the mobile computing device on which the application is being run to have a Global Positioning System (“GPS”) receiver, by which the application can know with relative certainty the location of the user by knowing the location of the device on which the application is being run.

In some other environments, particularly environments in which GPS functionality is impractical, an array of Bluetooth wireless technology sensors could be placed around the business property, and the application's locating engine would then be able to use radionavigation (e.g., triangulation or trilateration) to determine the user's location or the location of task items. Alternatively or additionally, Wi-Fi beacons could be used, albeit with greater power consumption requirements. Similarly, Radio Frequency Identification (“RFID”) sensors can be placed around the business property, with each user and each product having a unique RFID tag, and the application would then be able to communicate with the RFID sensors to retrieve the required locations through proximity or triangulation or other radionavigation methods. In other environments, it may simply be enough for the application to know the position of the user, with the application able to determine the location of a product by calculating its last known location on a virtual map (e.g., an aisle number or shelf location) and directing the user to that location. The item navigation function 104 can still be used, however, without any such positioning system or locating engine, as the compass function 602 would be omitted and the user would be able to navigate to the product location by some other system (e.g., an aisle numbering system or shelving location system).

Another embodiment is envisioned in which the application can use a positioning system as described above to provide pertinent information to the user based on the user's current location. For example, the application could show to a user walking down a retail store aisle pending task items that need attention within a certain proximity range of the user. As another example, for a user stationed near a conveyor belt with a steady stream of shipping boxes flowing down it, the application could present task items to the user, such as applying a particular label or removing a particular box from the conveyor belt, when the particular task item approaches the user's station. These proximity-based task assignments and refined positioning information can significantly reduce the number of steps and information that users will have to sort through in order to accomplish their required job duties, thereby greatly increasing each employee user's efficiency.

In one embodiment of the present invention, the application is designed to be run on a device which has a wireless data connection (e.g., Wi-Fi, Bluetooth, or cellular radio) (FIG. 25). With this connection, the application can communicate with a central server or servers (18, FIG. 25), or with other users who are logged into a similar instance of the application that is being run on other devices, or with any networked applications or devices including the Internet 12 (FIG. 25). By maintaining a connection with a central server or servers or with other users, the application can track inventory and logistical information in real-time, including the movement of products or users.

One benefit to this real-time tracking is that the application can determine whether the current user is the best person to which a task should be assigned. For example, if a task assignment is created on a central server 18 (FIG. 25), that server can broadcast the task assignment to all instances of the application which are being run by currently logged in users. Each user's instance of the application determines how congruent the task assignment is with that user, based on any pertinent data to which the application has access for that user or task. For example, the application may determine congruence based on: items' proximity to user's current or future location, user efficiency statistics, estimated time of task completion by user, whether the task can reasonably be completed before user's next scheduled break, user's estimated fatigue based on distance traveled, user's physical characteristics, items' physical characteristics, etc. The application ranks the congruence of the user to the task, determining if the user has sufficient or superlative congruence with the task assignment, and can notify the central server or the other users that the determined user shall accept the task assignment.

In the event that the application is run on a device that does not include wireless communication capabilities, the application can be run fully independently by receiving input via a wired connection. For example, after the user inputs his or her credentials on the login screen, the user can then connect a data transfer cable to the device on which the application is being run, in order to download or upload all required data for that user's work shift to DBMS 14 (FIG. 25). In this example, the application would not be able to track real-time locations of task items, or receive real-time task assignments, as it is able to do with a wirelessly connected device, but the employee user would still be able to carry out all of his or her required job duties with the help of the application.

When the employee user data collected by the application is uploaded to a server or servers 18 or an instance of the application which is being run on a device 24 used by a managerial user, that managerial user can view all desired statistics regarding the employee user. Thus, for example, the application can display statistics such as the user's average time to complete a task or average task assignment duration, or the user's efficiency in terms of number of items completed, or the user's mean time to complete a task assignment compared to the mean task assignment duration of all employee users via DBMS 14 (FIG. 25).

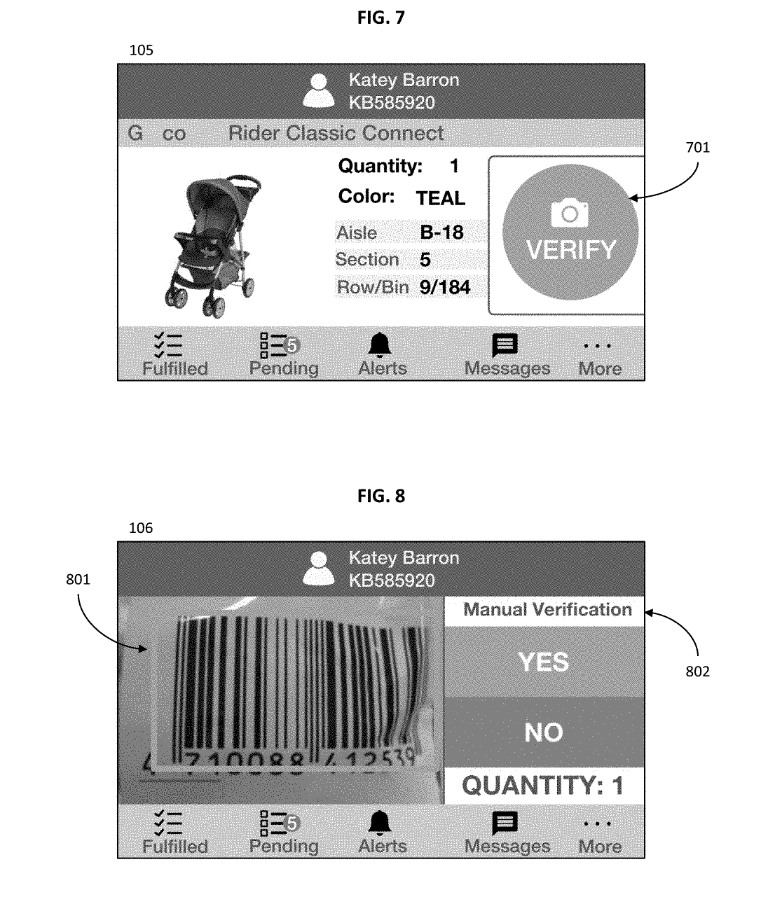

With reference now to FIGS. 7-8, this instance of the present invention includes multiple item verification functions. When the user has found the task item, or when the application has recognized that the user is near the physical location of the item, the application may prompt the user with an item verification function 105 screen. This screen includes a verification button 701, with which the user can verify that he or she has in fact obtained the product and completed the task item. Selecting this button 701 brings the user to the automatic verification function 106 screen, by which the user can automatically verify that the product has been obtained and the task item has been completed. In this instance of the application, the automatic verification function 106 screen displays a camera viewfinder 801 that is connected to a digital camera sensor on the mobile computing device on which the application is being run. The user can place an object identifier located on the product (e.g., a Stock Keeping Unit or “SKU” number, or a barcode as depicted in FIG. 8), in the field of view of the viewfinder 801, at which point the application scans and processes the object identifier to determine if it matches the product required by the task item. In other instances, the automatic verification function 106 may utilize an RFID scanner on the mobile device on which the application is being run, and RFID tags on the products to be obtained, in order to automatically verify the task item. In still other instances, the automatic verification function 106 may utilize any other suitable technology for determining whether a product is the one required by the task item. If the products do not have suitable means of identification such as barcodes or RFID tags, or if the mobile device on which the application is being run is not outfitted with a means of sensing those means of product identification, the user may opt to use the manual verification function 802. This manual verification function 802 allows the user to input that he or she has obtained what is believed to be the required product. Such information can be maintained and accessed via DBMS 14 (FIG. 25).

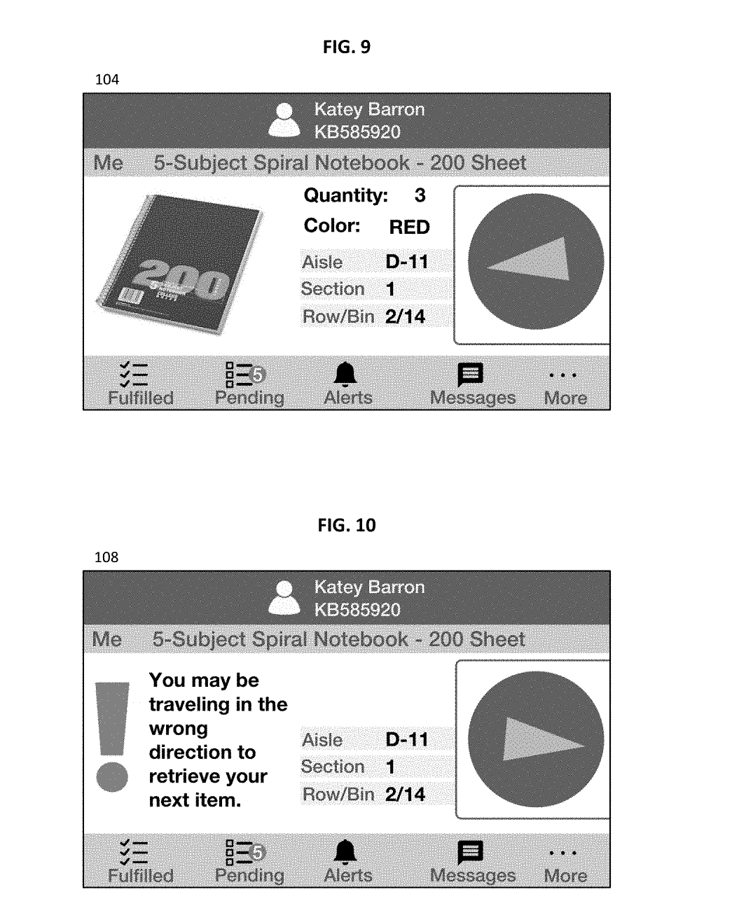

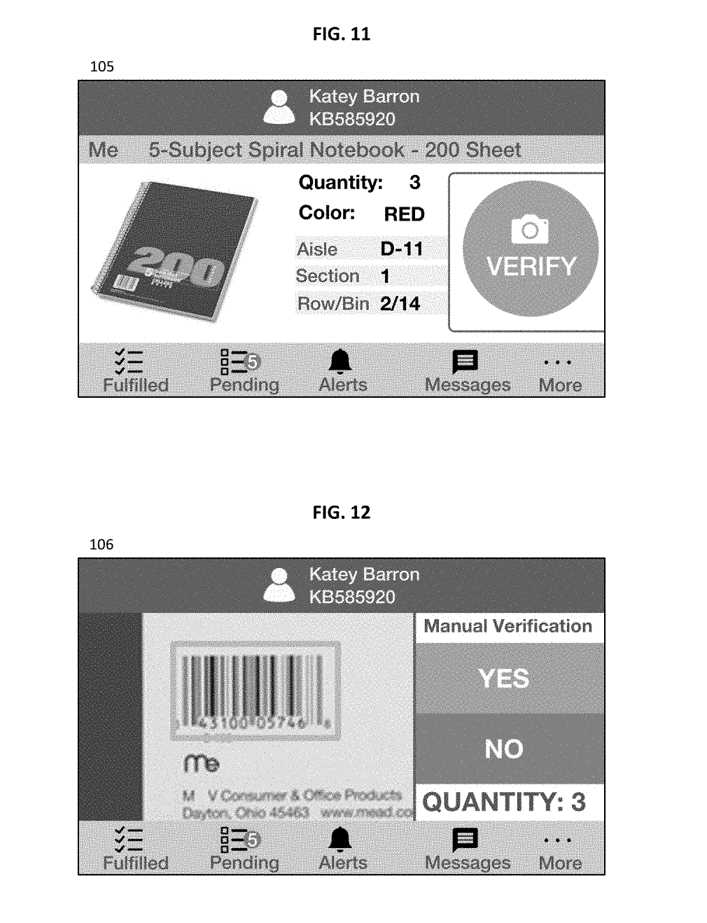

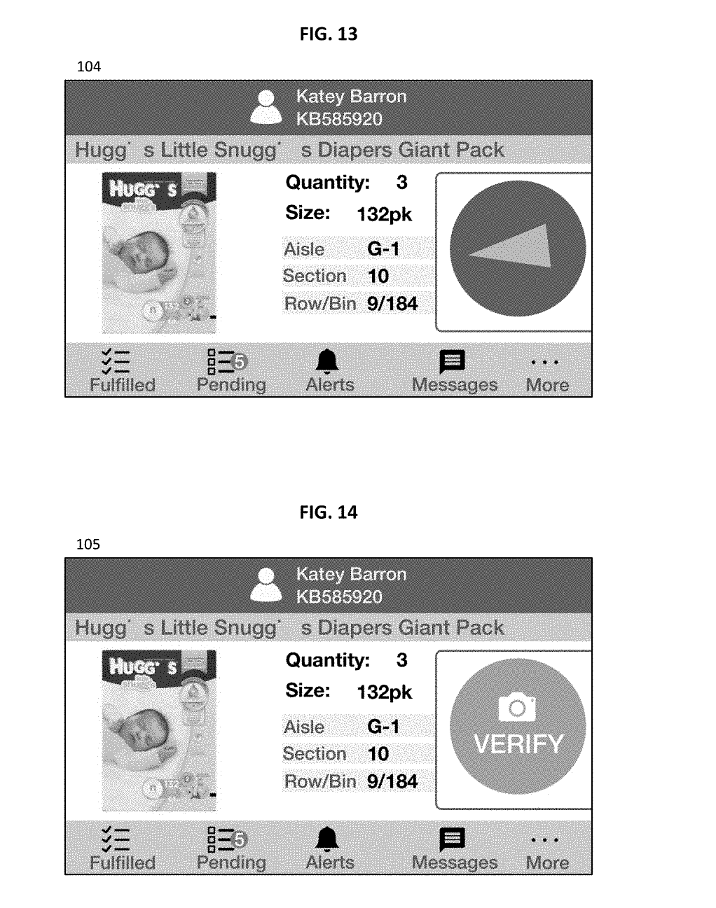

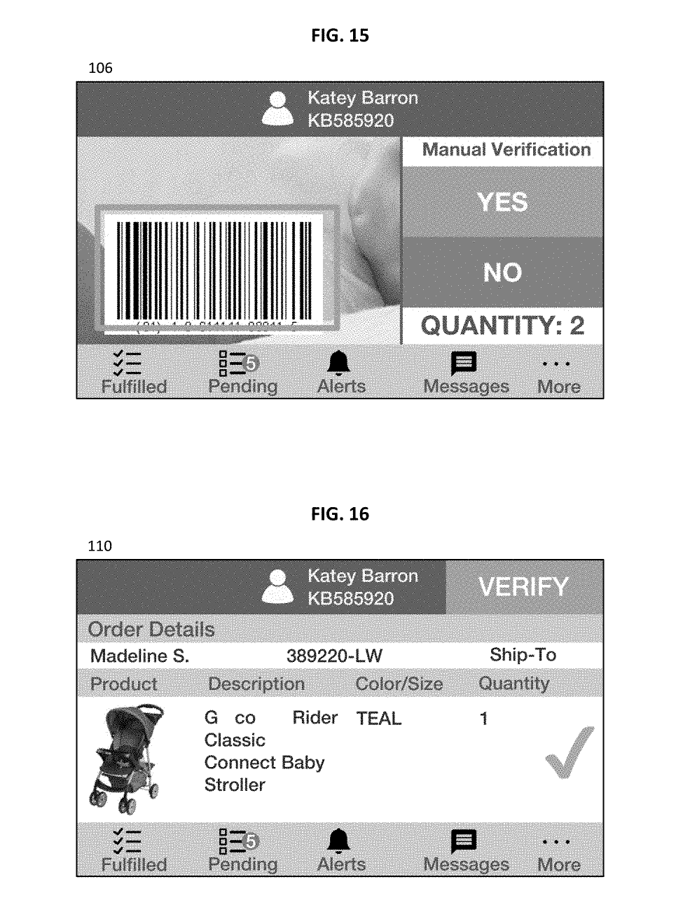

After verification functions, the application will check to see if there are additional items to be completed in the pending task. If there are other items to be completed in the pending task, the application will then display the item navigation function 104 screen for subsequent items, as shown in FIG. 9.

With reference now to FIG. 10, a “Hot/Cold” function 108 screen is shown as it would be displayed to the user while en route to an item. This functionality can be enabled or disabled, as shown in one of the setting sliders on the home screen 102. If enabled, the application can notify the user that they are nearing the location of the item to be picked, either by displaying a message on screen as shown in FIG. 10, or by using the display to flash different patterns or colors of lights to the user (e.g., slow flashes indicate that the user is far from the required item, or red flashes indicate that the user is near the required item), or by sounding an audible alert (e.g., a low frequency tone to indicate that the user is far from the required item, or a repetitive beeping tone to indicate that the user is near the required item), or by utilizing a haptic feedback unit in the mobile device 24 on which the application is being run (e.g., infrequent vibrations indicate that the user is far from the required item, or intense vibrations indicate that the user is near the required item), or by any other manner of conveying the user's distance or proximity to the required item.

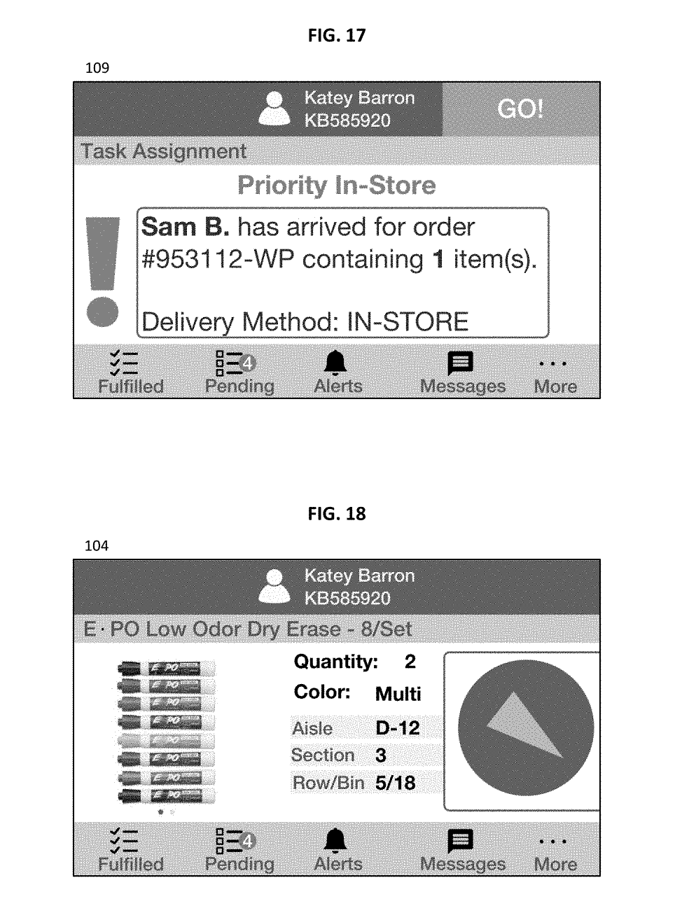

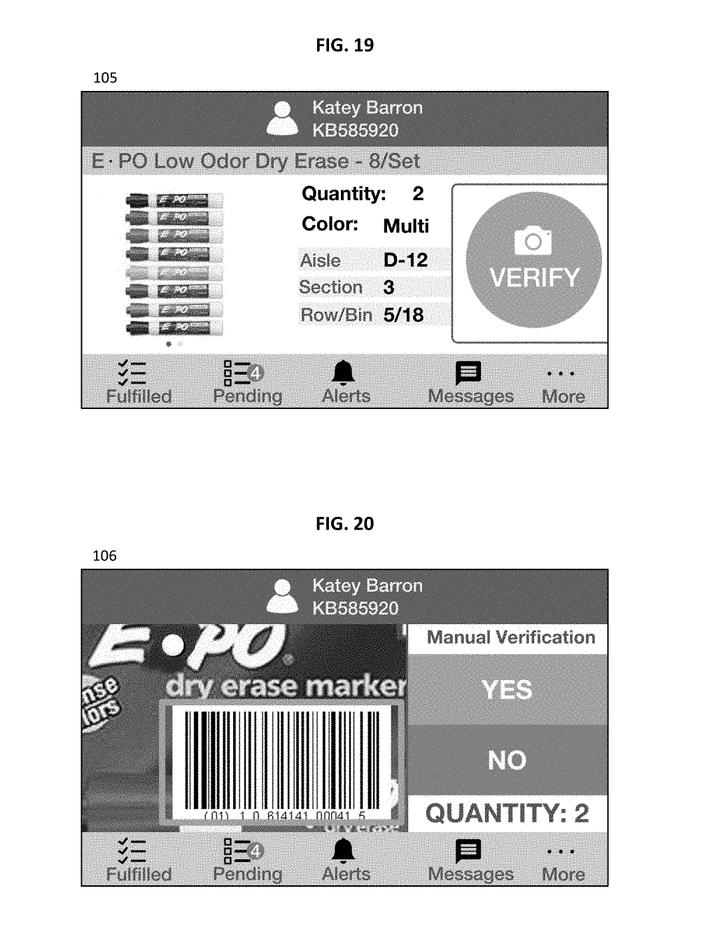

With reference now to FIG. 17, a priority message 109 screen can be displayed to the user, interrupting his or her current application activity, to inform the user of a pending task with a high priority, or a higher priority than the current task on which the user is working. For example, if the user is working on a pending task for a customer's product order to be shipped out with a deadline of two days, and a different customer has just submitted a product order to be picked up in-store within one hour, the user could be notified with the priority message 109 to cease work on the task with a two-day deadline, and to start work on the task with the one-hour deadline.

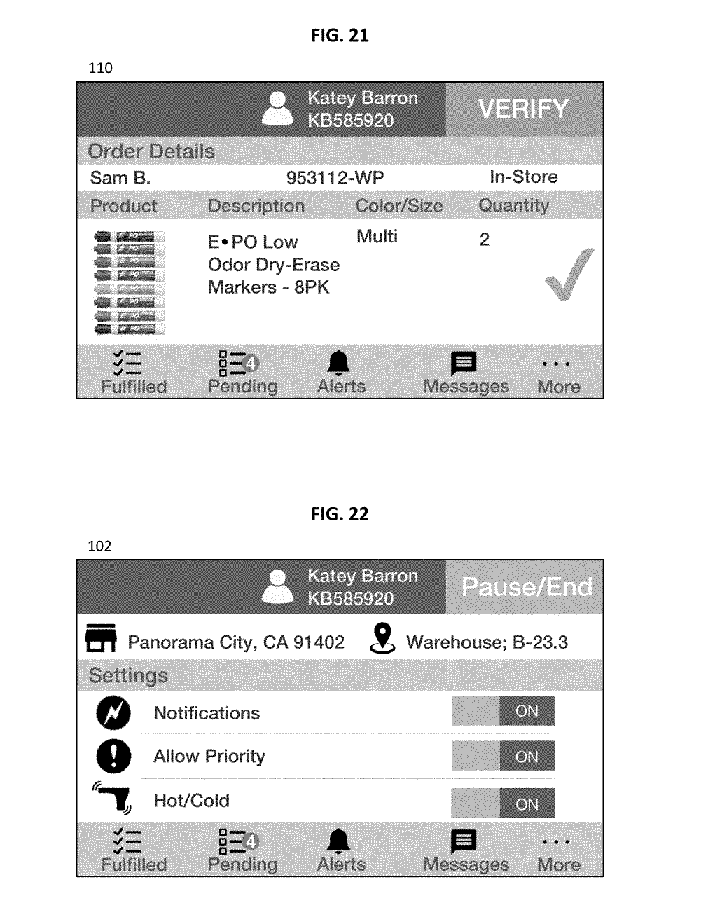

Upon completion of a task, the application will display a task completion overview function 110 screen, as shown in FIGS. 16 and 21. This function allows the user to see the task items in the completed task assignment, and to confirm that each task item has been verified, before marking the task assignment as complete. If there were multiple task items in the task assignment, the task completion overview function 110 screen allows the user to scroll through each task item to ensure that each task item was verified.

Subsequent to task completion, the user can be redirected to any of the other function screens. In the configuration depicted in FIG. 22, the user is redirected to the home screen 102 upon completion of a task. Other configurations are envisioned in which the user is redirected to the completed tasks function overview screen, or redirected to the task assignment overview 103 screen for the next queued pending task or the next pending task with the highest priority. As with the workflow from each of the application functions to the next, the manner of progress after task completion can be tailored to each user or each business to ensure optimal productivity.

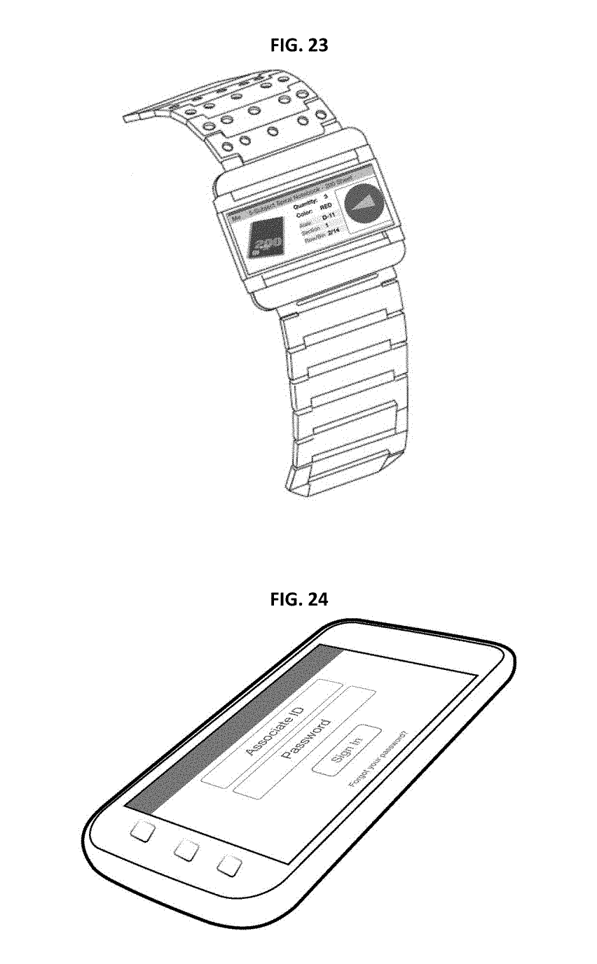

With reference now to FIGS. 23-24, an instance of the application is depicted as being run on a wrist-worn mobile computing device 24 (e.g., a Rufus Cuff®, available from Rufus Labs, Inc., of Los Angeles, Calif., or other suitable “smartwatch”), and on a mobile telephone device 24. The application can be run on any device with a computer processor having input and output capabilities and having connected storage memory. In the exemplary embodiment, the application preferably runs on mobile computing devices, to ensure the most functionality of the application and the best user experience for an employee. Furthermore, the use of a wrist-worn mobile computing device to run the application has an added benefit of allowing the user to keep their hands free of obstruction while performing manual work such as lifting product boxes.

The application can be utilized by a vast array of businesses in a vast array of different industries, to optimize their logistical efficiency. For example, the application could be used by parcel courier employees to more efficiently guide delivery persons to destination addresses and, when run on a wrist-worn device, would leave delivery persons' hands free to move shipping boxes. As another example, the application could be used by taxicab drivers to route drivers to requested hailings and to desired destinations and, when run on a wrist-worn device 24, would leave drivers' hands free to remain on the steering wheel of their taxicabs, instead of requiring manual input as is done currently with a smartphone or other mobile computing device. Furthermore, driving users could enjoy the application's item navigation function 104 to use different vibration signals to indicate left turns or right turns, in order to never have to take their eyes off of the road, as is done currently with smartphones or dashboard-mounted GPS navigation units. Aside from the above examples for business or employee use, the application can be enjoyed by personal users to input their own task assignments as a more efficient way of completing “to-do” lists.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which is to be considered illustrative rather than restrictive.

Although the invention has been disclosed in detail with reference only to the exemplary embodiments, those skilled in the art will appreciate that various other embodiments can be provided without departing from the scope of the invention. Accordingly, the invention is defined only by the claims set forth below.

What is claimed is:

1. A networked computer system for logistic management, comprising:
a networked server system accessible by remote user devices via a network, the networked server system comprising at least one processor and at least one memory; and
at least one database accessible by the networked server system that stores (a) data for registered users and (b) inventory data, including type, location;
a plurality of mobile computing devices in wireless communication with the networked server system, the device having a positioning system, in which each device of the plurality is logged to a registered user running a logistics application on the device;
the networked server system being programmed, via executable program instructions on non-transitory storage mediums, for:
broadcasting a task by the server system via wireless communications, to the plurality of mobile computing devices,
conducting a congruence assessment for each mobile device to assess whether the registered user of the device can accept the task,
transmitting the congruence assessment from each of the plurality of mobile devices to the server system, and
assigning the task based on the congruence assessments.

2. The system as defined in claim 1, the instructions further comprising transmitting a high priority task from the server to a mobile device of the plurality of devices, to interrupt a current task via a priority message display on the mobile device.

3. The system as defined in claim 1, wherein the congruence assessment of a task accounts for proximity of the registered user based on location, efficiency statistics of the registered user, estimated time of task completion by the registered user, or physical characteristics of the registered user.

4. The system as defined in claim 1, wherein the congruence assessment is conducted by each mobile device via the logistics application therein.

5. The system as defined in claim 4, wherein the congruence assessment calculates a ranking of congruence with the task assignment.

6. The system as defined in claim 1, the instructions further comprising determining efficiency statistics for a register used based upon average time to complete a task, average task assignment duration, number of items completed, or mean time to complete a task assignment compared to the mean task assignment duration of all employee users.

7. In networked computer system for logistic management, the system including networked server system comprising at least one processor and at least one memory; and at least one database accessible by the networked server system that stores (a) data for registered users and (b) inventory data, including type, location; a plurality of mobile computing devices in wireless communication with the networked server system, the device having a positioning system, in which each device of the plurality is logged to a registered user running a logistics application on the device; a computerized method comprising:
broadcasting a task by the server system via wireless communications, to the plurality of mobile computing devices;
conducting a congruence assessment for each mobile device to assess whether the registered user of the device can accept the task;
transmitting the congruence assessment from each of the plurality of mobile devices to the server system; and
assigning the task based on the congruence assessments.

8. The method as defined in claim 7, further comprising transmitting a high priority task from the server to a mobile device of the plurality of devices, to interrupt a current task via a priority message display on the mobile device.

9. The method as defined in claim 7, wherein the congruence assessment of a task accounts for proximity of the registered user based on location, efficiency statistics of the registered user, estimated time of task completion by the registered user, or physical characteristics of the registered user.

10. The method as defined in claim 7, wherein the congruence assessment is conducted by each mobile device via the logistics application therein.

11. The method as defined in claim 10, wherein the congruence assessment calculates a ranking of congruence with the task assignment.
